(19) United States
(12) Patent Application Publication
(10) Pub. No.: US 2011/0137687 A1
(43) Pub. Date: Jun. 9, 2011

(54) Insurance System

(75) Inventors: Ashley Robert Duddle, Hampshire (GB); Stephen Henry Perham, Surrey (GB)

(73) Assignee: Airmax Group PLC, Dorset (GB)

(21) Appl. No.: 12/962,742

(22) Filed: Dec. 8, 2010

(30) Foreign Application Priority Data
Dec. 8, 2009 (GB) 0921467.7

(51) Int. Cl. G06Q 40/00

(52) U.S. Cl. 705/4

(57) ABSTRACT

An insurance system for managing insurance for a group of members to be insured is provided. The system includes a group creation tool adapted to receive information relating to the members of the group to be insured and adapted to send the information of the group to an insurance provider and a premium calculator adapted to receive the information of the group and calculate a premium for the group based on said information.

### CROSS REFERENCE TO RELATED APPLICATIONS

This application claims benefit under 35 U.S.C. §119(a) of British Patent Application No. 0921467.7, filed Dec. 8, 2009, the entire contents of which are incorporated herein by reference.

### BACKGROUND OF THE INVENTION

1. Field of the Invention

This invention relates to an insurance system and, in particular, a group insurance system adapted to manage insurance to a pre-arranged group of individuals. This invention also relates to a method for managing insurance to a group. In particular, it relates to a method for managing group insurance to a pre-arranged group. It also relates to a method of soliciting for insurance for a group.

2. Description of Related Art

The provision of insurance, such as car insurance, is based on the calculation of risk of the individual having an accident or their car being stolen or damaged. It is known that certain profiles of individuals are inherently a greater risk than others. For example, statistics show that young male drivers have a higher tendency to be involved in accidents than middle aged women drivers. Accordingly, it is also known that present insurance providers create bundles of insured individuals and insure the bundle using statistical techniques to set the premiums for each individual driver. The factors used to create the bundles of insured individuals may be based on the engine size of the car, the type of the car, age, gender, accident history of the driver, where the car is kept overnight, the amount of night time driving, the amount of business use of the vehicle, the profession of the driver or combinations of the above or other factors.

Many insurance providers have significant expenditure relating to advertising for customers and, sometimes, particular types of customers. Thus, some insurance providers set out to attract specific types of drivers such as women, older people, or people with several years of “no claims discount”. By attracting customers of a particular type that are considered safe, the overall risk of a bundle of drivers is lower and therefore lower insurance premiums can be offered. Insurance providers also expend significant resources into the bundling of insured parties in order to appropriately cover the risk while remaining competitive.

### BRIEF SUMMARY OF THE INVENTION

According to a first aspect of the invention, we provide an insurance system for managing insurance of a group to be insured, the group comprising at least two members, the system comprising;

a group creation tool adapted to receive information relating to the members of the group to be insured and adapted to send the information of the group to an insurance provider;

a premium calculator adapted to receive the information of the group and calculate a premium for the group based on said information.

This is advantageous as the insurance system provides a quotation or premium based upon a group of individuals that are supplied to it by a member of the group. This system is particularly suitable for use in the provision of motor vehicle insurance and, in the interest of clarity, will be discussed hereinafter in relation to motor vehicle insurance. It will be appreciated that the system need not be limited to motor vehicle insurance. The overhead of bundling drivers is reduced as the group of drivers submitted via the group creation tool replaces the conventionally used bundle system.

Preferably, the group creation tool is adapted to receive information of the user of the tool (i.e. the chairman) and the other members of the group. Therefore the chairman recruits a group of customers for the insurance provider.

Preferably the insurance system includes a member removal tool adapted to receive information of at least one member of the group that is to be expelled from the group, the premium calculator adapted to recalculate the premium of the group based on group minus the expelled member or members. Alternatively or in addition, the insurance system may include a limitation tool adapted to receive information of at least one member of the group that is to be subject to different insurance conditions and limit the terms of the member's insurance. This may also involve on a recalculation of the premium of the group. Thus, a member of the group can be “sin binned” or a curfew applied for certain time.

Preferably the insurance system includes a member addition tool adapted to receive information on at least one potential new member of the group, the premium calculator adapted to recalculate the premium of the group based on group plus the added member or members.

The insurance system may include a payment tool adapted to receive payment details for payment of the premium and insurance registration means adapted to register the group as being insured after receipt of the payment details.

According to a second aspect of the invention, a method for managing insurance of a group, the group comprising at least two members, the method comprising:
providing a user with a group creation tool to enter information relating to the members to be insured as part of the group;
receiving the information relating to the members of the group;
generating an insurance premium for the group of individuals.

This is advantageous as the grouping of individuals to be insured is performed by a chairman of the group or a group administrator or administrators. Thus, the user is typically a member of the group and thus has an interest in keeping the insurance premium of the group low. Further, as the user or group administrator and other members of the group are collectively responsible for the premium, there is a pressure on the behaviour of the group to ensure the premium is kept as low as possible, by good driving for example.

The group creation tool may be a software application.

Preferably, the method also includes the step of providing insurance to the group in exchange for payment of the premium.

Preferably, the method additionally includes the step of providing means to administer the group once insurance has been provided comprising;
receiving details of a member or members of the group that are to be removed from the group;
calculating a new premium for the group based on the group with the member or members removed.

Preferably, the method additionally includes the step of providing means to administer the group once insurance has been provided comprising;
receiving details of a potential member or members to be added to the group;
calculating a new premium based on the group including the additional member or members.

According to a third aspect of the invention we provide a method of soliciting for insurance for a group, the method comprising;
forming a group comprising at least two members for the purpose of being insured as a group;
submitting details of the members of the group to an insurance provider;
receiving a premium for the provision of insurance for the group.

This is advantageous as the insurance company receives a pre-arranged group of customers for insurance. Also, the choice of members of the group is selected by the members themselves, or a chairman, and not the insurance company. The group may set its own rules for how members are chosen. These rules may be different from the rules of other groups. Therefore, the members of the group may receive a lower premium than if they were bundled by the insurance provider in accordance with the provider's selection criteria.

The method may include the steps of; identifying a potential new member for the group; providing details of the new member to the insurance provider of the group; and receiving a revised premium for insurance of the group including the potential new member.

This is advantageous as the chairman of the group or other group members will be encouraged to actively recruit new members with the motivation of reducing the premium of the group. Thus, the method may include the step of accepting the revised premium resulting in the potential new member becoming a member of the group.

The method may include the steps of; identifying a member of the group to be removed from the group; providing details of the member to be removed to the insurance provider; and receiving a quotation for insurance of the group without the removed member forming part of the group.

Thus, the chairman of the group or other members of the group will be actively encouraged to identify members of the group that are a higher risk and remove them from the group. Therefore, the members of the group can reduce the premium of the group by excluding certain members from the group. This may reduce the number high risk customers that the insurance provider insures.

The method may include the steps of; identifying a member of the group to have limitations placed on the provision of their insurance; providing details of the member to the insurance provider; and receiving a quotation for insurance of the group with the limitations placed on the identified member of the group.

Thus, the chairman of the group or other members of the group can actively ensure that the insurance for the more dangerous drivers in the group is limited to reduce the risk. Thus, bad drivers can be restricted to reduced a mileage or limited to day time driving only.

### BRIEF DESCRIPTION OF THE SEVERAL VIEWS OF THE DRAWINGS

There now follows, by way of example only, a detailed description of the present invention with reference to the accompanying drawings in which;

FIG. 1 shows a flow chart showing an embodiment for the management of group insurance;

FIG. 2 shows an embodiment of an insurance system;

FIG. 3 shows an embodiment of a group creation tool;

FIG. 4 shows an embodiment of a member removal tool;

FIG. 5 shows a flow chart illustrating an example of processing the removal of a member;

FIG. 6 shows an embodiment of a member addition tool;

FIG. 7 shows a flow chart illustrating an example of processing the addition of a member;

FIG. 8 shows an embodiment of a group selection tool; and

FIG. 9 shows a limitation tool.

### DETAILED DESCRIPTION OF THE INVENTION

An embodiment of the insurance scheme is described herein in relation to insurance for motor vehicles. It will be appreciated that other forms of insurance, such as home insurance, could be provided in accordance with the invention.

The majority of insurance companies provide call centres or websites for people who want insurance to obtain a quotation. The individuals supply information requested by the insurance company about them and their car. Using the information, the insurance company can calculate the risk associated with that individual so that a premium can be calculated. Insurance companies typically use the information collected to define bundles of insured drivers. The premiums are set by using statistical techniques to determine cost of insuring the bundle. The insurance company determines which individuals qualify for which bundle. Substantial resources are required by the insurance company to manage the system of bundling drivers and providing premiums. There is also substantial cost involved in attracting new customers and, in particular, low risk new customers. It is advantageous for an insurance company to attract safe, low risk, drivers as the more there are in each bundle, the more competitive the premium and the more profitable the insurance provider.

Individuals may not always get a good deal with the present method of the insurance provider bundling drivers together. For example, a safe driver may be bundled with high risk drivers on the basis of the high performance car they drive. Therefore, their premium may be unfairly high.

The present method allows the individuals to form their own groups to be insured as a group rather than the insurance company forming their own bundles.

It is advantageous to provide insurance in this way as the self formed group has a sense of belonging and community and a responsibility to the other members of the group to be a low risk. Thus, peer pressure plays a role in ensuring that each member attempts to be a low risk. This can lead to safer driving to ensure that the premium of the group does not increase.

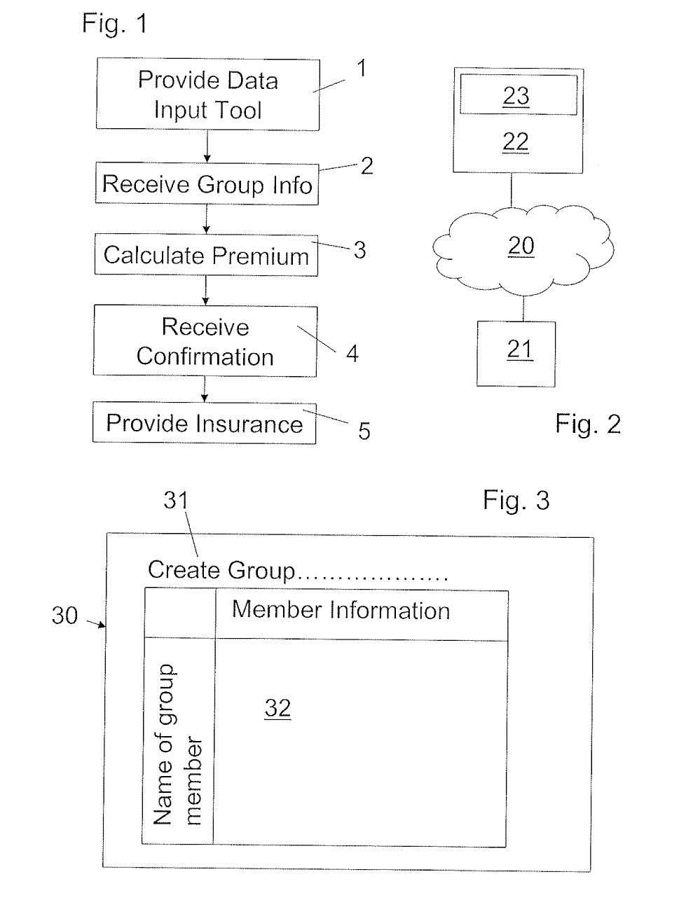

Thus, with reference to FIGS. 1, 2 and 3, the insurance provider provides a group creation tool 30 at step 1, which in this embodiment is software presented via the World Wide Web 20. The tool 30 is received via the user's computer 21 and allows the individual to enter details of the group of individuals that would like insurance as a group. The individual may be the secretary of a club, a member of a company or one of a group of friends. The individual responsible for administration of the group will be referred to as the chairman. Thus, as shown in FIG. 3, the chairman may be required to define a group 31 and complete a table 32 that lists the members of the group and selected information about each member. The selected information may be sex, age, car, address, number of years of “no claim discount”, motoring points or convictions, value of the car and where the car is kept overnight or other appropriate information.

At step 2, the chairman completes the forms and submits this information to the insurance company. An insurance server 22 is provided, which may be a computer server running software to operate as an insurance system. The insurance server 22 at the insurance provider receives the group information, which includes details of at least two individuals. A premium calculator 23, which is software, determines the risk from the information provided and returns a premium for the group at step 3. The chairman can then choose to accept or reject the offer of insurance at the premium quoted. There may be a system to allow selected or all members of the group to vote on whether or not to accept the premium.

The chairman can confirm whether or not the premium is acceptable by selecting an appropriate option. At step 4 the server 22 receives the confirmation from the chairman. Depending on the confirmation, insurance is provided or not. Step 5 shows insurance being provided and this step includes the relevant processes required to do so. This may include known methods of taking payment such as over a secure internet connection.

Thus, the chairman or other recruits actively recruit the individuals for the group. This reduces the cost to the insurance company. Also, as the chairman selects the members of the group, he can keep his own insurance premium down by selecting safe drivers to join his group. Thus, an owner of a performance car can save money by administering a group containing safe drivers or drivers with lower powered cars. The chairman of the group may be offered an incentive to create and administer the group. Incentives include a reduction in their payment to the premium of the group or a “cash back” award or improved insurance provisions, such as a guaranteed courtesy car or breakdown recovery. Members may join groups for their affiliation with their club or football team, for example. Thus, the groups can be created to appeal to supporters of sport, fans of musician or supporters of charities. Insurance companies may be able to offer more competitive premiums to groups, as the overheads in attracting that number of new customers is reduced. Further, it may be found that groups are a lower risk than the sum of the individual risks of the members, as the sense of responsibility to the group encourages safer driving.

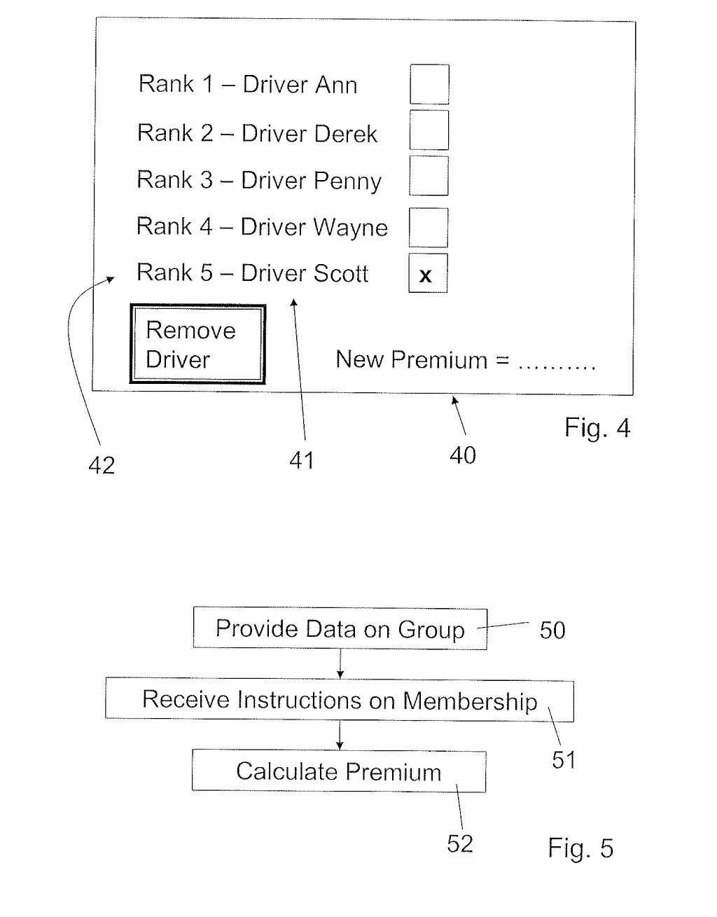

FIG. 4 shows an additional feature of the group insurance system. The insurance server 22 provides the chairman with an option to remove individuals from the group. The server 22 provides the chairman with a member removal selection tool 40. The member removal tool 40 presents a list 41 of members of the group. In this embodiment, the removal tool 40 also provides a ranking 42, which lists the members of the group from the lowest risk to the highest risk. Thus, Ann is the safest driver and therefore her presence in the group typically acts to reduce the overall group premium. Scott is the highest risk driver who typically acts to increase the overall premium of the group. The chairman has selected Scott to be removed from the group as it has been decided that he is too high a risk due to him making a recent claim. The chairman may decide this or means may be provided for a vote of members to occur.

Thus at step 50 the insurance server provides the names of the members and the rankings of the members in the group. At step 51, the server receives instructions from the chairman that Scott should be removed from the group. At step 52, the new premium is calculated for the group. Therefore, the chairman and maybe also the members of the group will identify and exclude bad risks. This is advantageous for the insurance provider as its customers are encouraged to reduce the risk of their group therefore improving the overall risk profile of the insurance provider's customers. This reduces the administration costs for the insurance provider as well as advertising costs as the groups will attract safe drivers rather that extensive advertising being required.

The system may also include a limitation tool as shown in FIG. 9. Thus, instead of immediately using the member removal tool 40, the chairman or other members may wish to apply a punishment to Scott for his poor driving. The limitation tool can be used to limit the terms of the insurance that apply to Scott. For example, Scott may be prohibited from driving for a week. Alternatively, a curfew may be applied such that he is prevented from driving after 10 pm and before 5 am. The punishments available via the limitation tool may be predetermined by the insurance provider or may be defined by the chairman or other members. Further the limitation tool may include a voting feature so that the members of the group can vote for the punishment that should be applied to Scott, if any punishment at all. Further, the limitation tool may form part of the member removal tool 40 and the system may be arranged to require the limitation tool to be used a predetermined number of times before a particular member can be removed from the group. Thus, it may be arranged that each member has a number of chances to improve their driving and the limitation tool will be applied to them with each failure. After a predetermined number of failures they are eligible for removal from the group.

The limitation tool may be used to limit the performance or change the driving characteristics of Scott's car. A programmable module that interfaces with the Electronic Control Unit (ECU) of the car is adapted to alter the car's ECU in response to signals received wirelessly. The programmable module is connectable to a mobile telephone network and is adapted to receive encrypted programming signals from the insurance system. Thus, the limitation tool may include the option to limit the speed that the car can reach. Alternatively, it may limit the revs that the car can reach which results in more measured acceleration. The limits that the limitation tool applies to the car's ECU may also be linked to the premium that is calculated. Thus, when the limitations are in place, the car and driver are, on average, statistically safer drivers and therefore the premium calculator may adjust their contribution to the group's premium.

Thus, in FIG. 9, the limitation tool 90 shows a selection of predetermined policy limitations 91 and a selection of car limitations 92. The chairman has selected to limit the mileage that Scott can drive within a period and also to limit the maximum speed at which Scott's car will move. The length of time that the limitation will apply for is entered at 93 and then submitted to the insurance system by actuation of button 94. On submission to the insurance system, a message is sent to Scott informing him of the limitations imposed on him. The insurance system also causes Scott's car's ECU to be reprogrammed to effect the speed limitation. A further reprogramming will occur at the end of the limitation period to remove the limitations from the ECU.

If driver Scott was ultimately removed from the group he may be required to insure himself as an individual or use a difference insurance company. Alternatively he may be moved to a different group. Thus, he may be eligible to join a different group based on the car he drives, where the premium is more appropriate for his risk. The insurance system may provide a league of groups through which a driver may be demoted when being removed from a group. Further, a member of a group may apply for promotion to a different group in the league, which has a lower premium. The time of promotion may be determined by the insurance system.

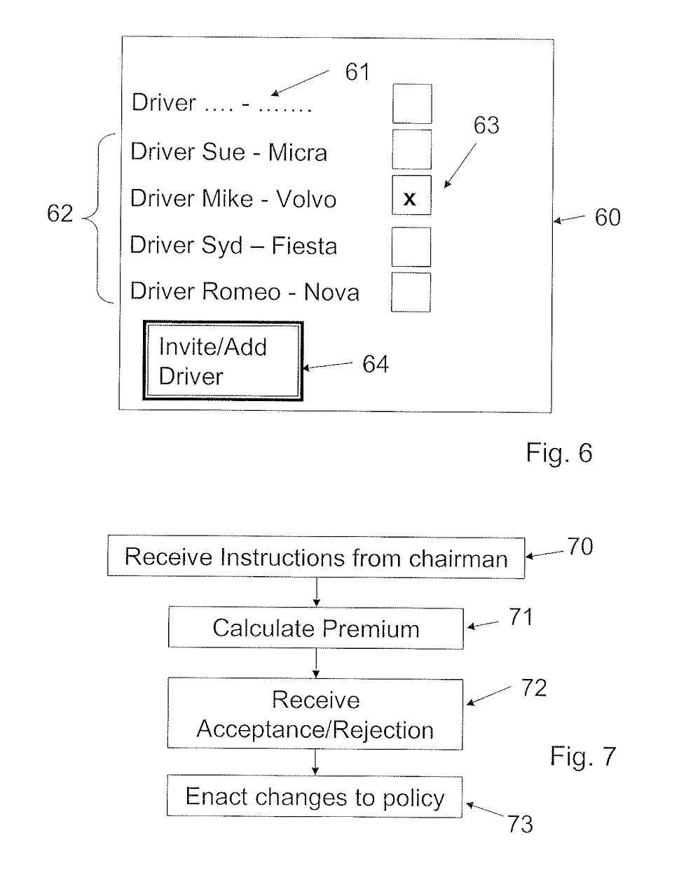

FIG. 6 shows a member addition selection tool 60 for adding new members to the group. The member addition tool 60 is provided to the chairman's computer 21 by the insurance server 20. The addition tool 60 includes a data input area 61 to enter a new member not known to the group insurance system. The name of the new member and their car can be entered here. However, the chairman may then be taken to a further screen where more comprehensive information can be entered, similar to that entered in table 32. The addition tool 60 also includes details 62 of individuals already known to the group insurance system. It may be that these known individuals have been expelled from other groups. Alternatively, they may be desirous in joining a pre-existing group or may be eligible for promotion from an existing group.

The chairman can select one or more of the individuals using the selection boxes 53 and then submit his request to the insurance server 22 using button 64 (step 70). In FIG. 6, the chairman has selected Driver Mike to join the group. The insurance server 22 receives the information from the chairman and uses the premium calculator 23 to calculate the new premium (step 71) for the group should Mike join. The chairman may then approve or recall his request for Mike to join. On approval, the insurance server 22 sends a message (step 72), which may be an email, to Mike informing him of his invite into the group and details of the group's premium. Mike can then accept or reject the invitation to join the group (step 73). The insurance server communicates Mike's decision to the chairman (step 74) and provides any changes to the membership of the group and group insurance policy, as appropriate.

The member addition tool 60 may include the option of applying a probationary period in which the driving of the new member or potential new member can be monitored. The insurance system may therefore include a probation period reporter that collects information about the driving style of the member or potential new member and presents it to the chairman. Thus, during the probationary period the insurance system may present the chairman with reports on the driving of the new member or a rating. After the probationary period has expired, the chairman can then use the member addition tool to submit his decision to formally accept the new member into the group or reject them.

The limitation tool may also be used when adding members to the group. For example, new members of the group or potential new members of the group may be subject to limitations in their insurance until they have “proved” themselves as being sufficiently safe. This may be during their probationary period or may be for a longer or shorter amount of time.

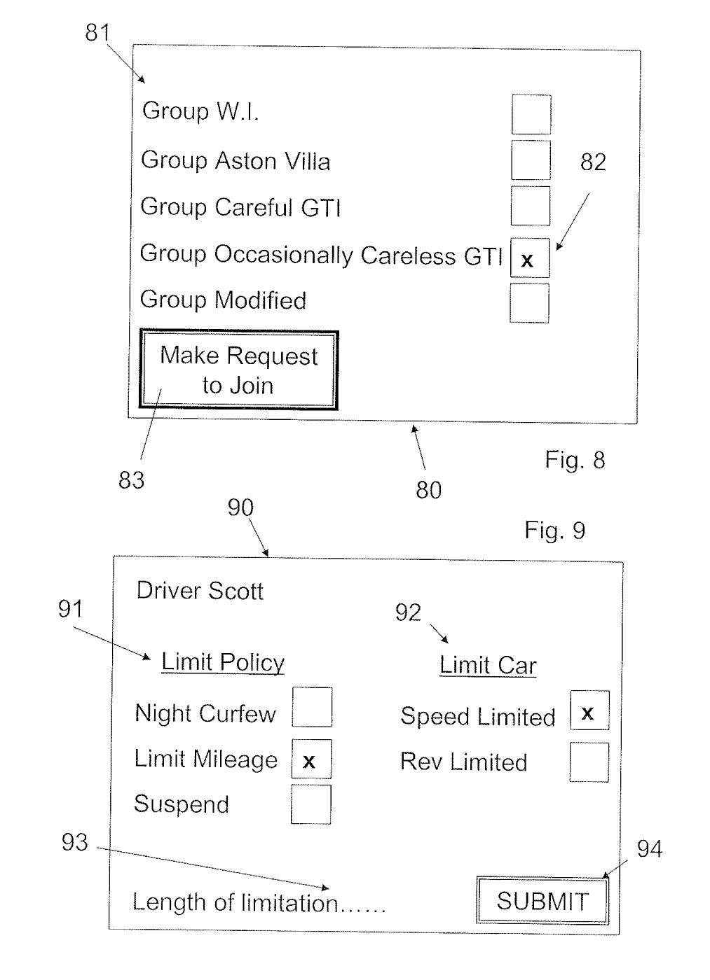

FIG. 8 shows a group selection tool 80 for selecting a group. The insurance server 22 presents the tool to a user to enable them to make a selection on the group to join. Thus, a list 81 of groups is presented, which may include a description of the types of members in the group or the premium. Selection boxes 82 are provided to enable a user to select a group they would like to join. For example, Scott, who was removed from his group, which may have been the “Careful GTI” group, could select the “Occasionally Careless GTI group” and submit his request with button 83. Scott may then appear in the list of drivers to add 62 of selection tool 60 to the chairman of the Occasionally Careless GTI group. Alternatively, the insurance server 22 may send the chairman of the Occasionally Careless GTI group a message expressly stating Scott's request to join the group with an option for him to accept or decline Scott's request.

Each member of the group may receive feedback on their driving based on predetermined risk factors. Thus, the system may be adapted to assess the average mileage of a member, the amount of night time mileage and the amount of fast driving, which may be the percentage of driving over the speed limit for the particular road they are travelling along. The system may allocate points based and the above factors and create warnings depending on whether a member is close to or exceeded set thresholds.

Thus, a member may indicate the maximum mileage they intend to cover in the year that the insurance is provided (the system may use other durations). The member could agree a maximum mileage of; 3,000, 5,000, 7,500, 10,000 or 13,000 miles. A warning may be generated if the member exceeds the equivalent monthly maximum mileage.

A member may receive warnings or incur points depending on their driving. The warnings may be advisory and prompt the member to improve their driving habits. Points will accumulate and when they exceed 12 points, the insurance policy could be cancelled or the chairman and/or other group members may be informed. The member could then be removed from the group using the member removal tool.

A traffic light system can be used to reflect the number of points the member has incurred and any warnings they have received:

| Colour | Points |
|---|---|
| Green | 0-2 |
| Amber | 3-8 |
| Red | 9+ |
| Black - to indicate | 12 |
| loss of insurance | |

A report of the points and warnings may be emailed to each member Points may be removed from a policy under special circumstances and may be performed by a further tool under the control of the chairman or other group members, for example.

Although the embodiment described herein relates to a group of individuals, the group may include other groups or a combination of individuals and groups.

1. An insurance system for managing insurance for a group of members to be insured, the system comprising;
a group creation tool adapted to receive information relating to the members of the group to be insured and adapted to send the information of the group to an insurance provider;
a premium calculator adapted to receive the information of the group and calculate a premium for the group based on said information.

2. An insurance system according to claim 1, in which the group creation tool is adapted to receive information of the user of the tool and the other members of the group.

3. An insurance system according to claim 1, in which the insurance system includes a member removal tool adapted to receive information of at least one member of the group that is to be expelled from the group, the premium calculator adapted to recalculate the premium of the group based on group minus the expelled member or members.

4. An insurance system according to claim 1, in which the insurance system includes a member addition tool adapted to receive information on at least one potential new member of the group, the premium calculator adapted to recalculate the premium of the group based on group plus the added member or members.

5. An insurance system according to claim 1, in which the insurance system includes a probation period reporter adapted to collect information regarding the risk of a member or potential new member and present said information.

6. An insurance system according to claim 1, in which the insurance system includes a payment tool adapted to receive payment details for payment of the premium and insurance registration means adapted to register the group as being insured after receipt of the payment details.

7. An insurance system according to claim 1, in which the insurance system includes a limitation tool adapted to receive information regarding the identity of a member and information of a limitation to be applied to the member, the insurance system adapted to modify terms of insurance that apply to the member in accordance with the received information.

8. A method for managing insurance to a group, the group comprising at least two members, the method comprising:
providing a user with a group creation tool to enter information relating to the members to be insured as part of the group;
receiving the information relating to the members of the group;
generating an insurance premium for the group of individuals.

9. A method according to claim 8, in which the group creation tool is a software application.

10. A method according to claim 8, in which the method also includes the step of providing insurance to the group in exchange for payment of the premium.

11. A method according to claim 8, in which the method additionally includes the step of providing means to administer the group once insurance has been provided comprising;
receiving details of a member or members of the group that are to be removed from the group;
calculating a new premium based on the group with the member or members removed.

12. A method according to claim 8, in which the method additionally includes the step of providing means to administer the group once insurance has been provided comprising;
receiving details of a potential member or members to be added to the group;
calculating a new premium based on the group including the additional member or members.

13. A method according to claim 8, in which the method additionally includes the step of providing means to administer the group once insurance has been provided comprising;
receiving information of a member or members of the group to be punished;
receiving information of a punishment;
amending the conditions of insurance for the identified member or members to incorporate the punishment.

14. A method according to claim 8, in which the method additionally includes the step of providing means to administer the group once insurance has been provided comprising;
receiving information of a member of the group or potential new member of the group;
monitoring the risk of the member or potential member over a predetermined period;
providing information based on the information gathered during the monitoring step.

15. A method of soliciting for insurance for a group, the method comprising;
forming a group comprising at least two members for the purpose of being insured as a group;
submitting details of the members of the group to an insurance provider;
receiving a premium for the provision of insurance for the group.

16. A method according to claim 15, in which the choice of members of the group is selected by the members themselves.

17. A method according to claim 15, in which the method includes the steps of; identifying a potential new member for the group; providing details of the new member to the insurance provider of the group; and receiving a revised premium for insurance of the group including the potential new member.

18. A method according to claim 15, in which the method includes the steps of; identifying a member of the group to be removed from the group; providing details of the member to be removed to the insurance provider; and receiving a revised premium for insurance of the group without the removed member forming part of the group.

19. A method according to claim 17, in which the method includes the step of accepting the revised premium resulting in the membership of the group being revised.

20. A method according to claim 18, in which the method includes the step of accepting the revised premium resulting in the membership of the group being revised.
